(19) United States
(12) Patent Application Publication
(10) Pub. No.: US 2009/0251675 A1
(43) Pub. Date: Oct. 8, 2009

(54) EXPOSURE DEVICE

(75) Inventors: Kenichi Masumoto, Osaka (JP); Tetsurou Nakamura, Hyogo (JP); Kei Sakanoue, Fukuoka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/996,197

(22) PCT Filed: Jul. 13, 2006
(86) PCT No.: PCT/JP2006/313951

§ 371 Date: Jan. 18, 2008

(30) Foreign Application Priority Data
Jul. 19, 2005 (JP) 2005-208103

(51) Int. Cl. G03B 27/72

(52) U.S. Cl. 355/69

(57) ABSTRACT

In an exposure device having tiny light emitting elements aligned, a space required for drive circuits and wires is secured without affecting the size or alignment of the light emitting elements for arrangement and wiring of the drive circuits. In this exposure device, the drive circuits are separately arranged outside the column formed by the multiple organic EL elements, and, the length of the region occupied by the circuit exceeds one pitch in the alignment of the organic EL elements, and, the multiple drive circuits are arranged along the column.

### TECHNICAL FIELD

The present invention relates to an exposure device that is equipped with a light emitting means having multiple tiny aligned light emitting elements, and that irradiates a light to a photosensitive body arranged outside the exposure device.

### BACKGROUND ART

Recently, in an exposure device for an electrophotographic system printer using a photosensitive body, a configuration where multiple tiny elements, such as liquid crystal or light emitting diodes (LEDs), are aligned and predetermined exposure is conducted to a photosensitive body by controlling each of the tiny elements has been often adopted. As one of the tiny elements, since organic electroluminescence (EL) light emitting elements can be easily produced and miniaturized, applications to various fields have been sought, and especially adopting the merit where the tiny elements can be easily produced, they are also used for an optical line head in an exposure device, and a high-resolution printer can be provided as the exposure device using the solid device instead of a general laser scanning unit.

For pursuing high resolution in the exposure device using the solid device, a light emitting array where many light emitting elements, which are equivalent to pixels in a densely arranged formed image, are required, and technologies for drive circuits that drive the emission of the many light emitting elements have been aggressively developed along with the pursuit.

In other words, for driving the organic EL light emitting elements, an integrated circuit (IC) is often used. However, in a light emitting array where multiple light emitting elements are arranged, as the number of elements to be driven is increased, the scale of the drive IC itself is enlarged, and the wiring volume from the drive IC to the light emitting array is increased, preventing miniaturization and cost increase.

For resolving these problems, an integral formation of drive circuits and an organic EL light emitting array using thin film transistors (TFTs) is proposed. With this proposal, the structure becomes simpler compared to using a LED array where a drive IC is separately arranged, and simplification of production process and miniaturization of an exposure device and an entire printer using the exposure device can be expected.

For example, as one where the number of drive wires and the number of drive circuit elements in a printer head are drastically reduced, the configuration described in FIG. 8 of Patent Citation 1 is proposed, in which a configuration where one drive circuit composed with TFTs is adjacently arranged and formed in the vicinity of organic EL elements comprising the light emitting elements that are the subjects for driving.

Further, the multiple organic EL elements are for a display unit, and a configuration where drive circuits are arranged side by side close to the organic EL elements, which are subjects for driving, within a region per pixel of a displayed image is disclosed in FIG. 1 of Patent Citation 2 and FIG. 1 of Patent Citation 3, as well.
[Patent Citation 1] Patent Publication No. 29422330
[Patent Citation 2] Japanese Laid-Open Patent Application Publication No. 2000-227771
[Patent Citation 3] Japanese Laid-Open Patent Application Publication No. 2003-15548

### SUMMARY OF THE INVENTION

Resolution of images to be handled by a printer is generally several times higher than that of display units, and in addition, when high quality printing is pursued, higher resolution is required. Therefore, in a line head of the exposure device, the organic EL elements, which are light emitting elements, become tinier corresponding to the high resolution and are densely aligned at pitches equivalent to the high resolution. In the meantime, in the drive circuits, their circuit configuration is not basically changed according to the size of the organic EL element. As a result, the region required for each drive circuit becomes relatively large compared to the size of each organic EL element. Therefore, in the configuration where the organic EL elements and their drive circuits are adjacently arranged with each other within a pitch corresponding to one pixel, the layout of the drive circuits becomes difficult.

In other words, for example, in an exposure device whose resolution is 200 dpi, light emitting elements are aligned at pitches of 127 μm, and a region corresponding to one pixel can also be enlarged to the size of the pitch. In the meantime, the drive circuits containing TFTs whose size is approximately 4 μm per element can be arranged in a portion within a region corresponding to one pixel, or a region adjacent to the light emitting elements, which are subjects for driving, and the arrangement is easy. For the purpose of controlling performance loss and characteristic variation due to connected wires, the drive circuits can be arranged in the vicinity of corresponding light emitting elements, respectively.

However, for example, when an optical line head for 2,400 dpi of resolution is configured, the arrangement pitch of the organic EL elements is 10.9 μm. In the meantime, the drive circuit containing TFTs requires three or more transistors depending upon the circuit system, making it impossible to arrange the drive circuit in a portion within the region corresponding to one pixel.

In a configuration where the organic EL elements and their drive circuits are aligned very close to each other within a region corresponding to one pixel, as described in the Patent Citation 2 or 3, it is difficult to lay out the drive circuits. In addition, the regions for the organic EL elements are narrowed due to the regions occupied by the drive circuits. As a result, the quantity of light emission is reduced. In addition, if the pixel becomes small, it is necessary to increase the luminescence. However, if the drive circuit approaches the organic EL element, the generation of heat in the drive circuit affects the organic EL element, causing variation in emission characteristics and performance and the deterioration of the organic EL element.

Even if the drive circuit is arranged in a region adjacent to the organic EL element outside the region corresponding to one pixel, in a configuration where an organic EL element and a drive circuit that drives said element are arranged within a pitch corresponding to one pixel as in the form shown in Patent Citation 1 and are aligned per light emitting element, the length (width) of the region of the drive circuit has to be less than a pitch where the organic EL elements are aligned in the direction of arrangement of the organic EL elements in line, and for example, if two elements of transistors are aligned, a gap where a pattern between the transistors can penetrate becomes 2 μm or less, which wiring is actually impossible. Therefore, the transistors must be aligned making the shape of the drive circuits a strip, and it becomes difficult to lay out the circuits and the wiring between the component transistors becomes complex, simultaneously increasing the area of the region occupied by the drive circuit.

Further, miniaturizing circuit elements to resolve the problems mentioned above increases the number of the drive elements. As a result, the scale of the entire drive circuits becomes larger increasing the heat in the drive circuit. Another concern is that the heat may also cause further deterioration in characteristics and/or lifetime shortening of the organic EL elements.

The present invention resolves the problems in the prior art, and has the objective of providing an exposure device with high resolution where the arrangement and wiring of the drive circuits that drive tiny light emitting elements aligned are optimized without affecting the size and alignment of the light emitting elements.

To accomplish this objective, the present invention provides an exposure device for irradiating a light to a photosensitive body arranged outside the device, comprising: light emitting elements each configured to emit a light; drive circuits having circuit elements containing thin film transistors, the circuits being formed one on one to the light emitting elements, and being configured to drive light emission of the corresponding light emitting elements; drive circuit wires configured to electrically connect the light emitting elements to the corresponding drive circuits that drive the light emitting elements; and a single substrate where the light emitting elements, drive circuits, and drive circuit wires are formed on the surface, wherein the light emitting elements are densely aligned, and the drive circuits are arranged outside a column formed by the light emitting elements, and, the length of a region occupied by at least one or more circuits in the column direction exceeds one pitch in the alignment of the light emitting elements, and the drive circuits are arranged along the column.

Further, the present invention can provide an exposure device for irradiating a light to a photosensitive body arranged outside the device, comprising: light emitting elements each configured to emit a light; drive circuits having circuit elements containing thin film transistors, the circuits being formed one on one to the light emitting elements, and being configured to drive light emission of the corresponding light emitting elements; drive circuit wires configured to electrically connect the light emitting elements to the corresponding drive circuits that drive the light emitting elements; and a single substrate where the light emitting elements, drive circuits, drive circuit wires are formed on the surface, wherein the light emitting elements are densely aligned, the drive circuits are arranged outside a column formed by the light emitting elements, and the lengths of regions occupied by all circuits in the column direction exceed one pitch in the alignment of the light emitting elements, and these drive circuits are arranged along the column, and the drive circuit wires are wired so as to be substantially the same in length.

In the present invention, the multiple drive circuits are separately arranged outside the column formed with multiple light emitting elements and the lengths of regions occupied by the circuits in the column direction are set to exceed one pitch in the alignment of the light emitting elements and these multiple drive circuits are arranged along the column. Thereby, size and alignment of the light emitting elements can be optimized without being affected by the arrangement of the drive circuits.

The present invention effectively enables an exposure device where the generation of heat in the drive circuits can also be prevented from affecting the light emitting elements, and the quantity of irradiation light can be sufficiently secured even with high resolution, and characteristics and performance are stable with high resolution and high image quality.

### BRIEF DESCRIPTION OF THE DRAWINGS

FIG. 1 is a top pattern diagram where a portion of an optical line head in an exposure device relating to the first embodiment of the present invention is enlarged.

FIG. 2 shows another example of an optical line head in an exposure device.

FIG. 3 shows another example of an optical line head in an exposure device.

FIG. 4 shows another example of an optical line head in an exposure device.

FIG. 5 shows another example of an optical line head in an exposure device.

FIG. 6 is a top pattern diagram where a portion of an optical line head in an exposure device relating to the second embodiment of the present invention is enlarged.

FIG. 7A is a perspective pattern diagram where a portion of the optical line head having multiple layers where drive circuits are formed is enlarged, and FIG. 7B is its cross sectional pattern diagram.

FIG. 8 shows one example of the drive circuits and wiring in an optical line head where light emitting elements are arranged zigzag.

FIG. 9 shows one example of the drive circuits and wiring in an optical line head where light emitting elements are arranged stepwise.

### DETAILED DESCRIPTION OF THE INVENTION

Embodiments of the present invention are described hereafter with reference to the attached drawings.

### First Embodiment

A device relating to this embodiment is an exposure device for an electrophotographic system printer using a photosensitive body, and the exposure device is equipped with an optical line head having an organic EL element array where multiple organic EL elements are aligned, and each of the elements is controlled and a light is irradiated, and predetermined exposure is conducted to a photosensitive body arranged outside the exposure device.

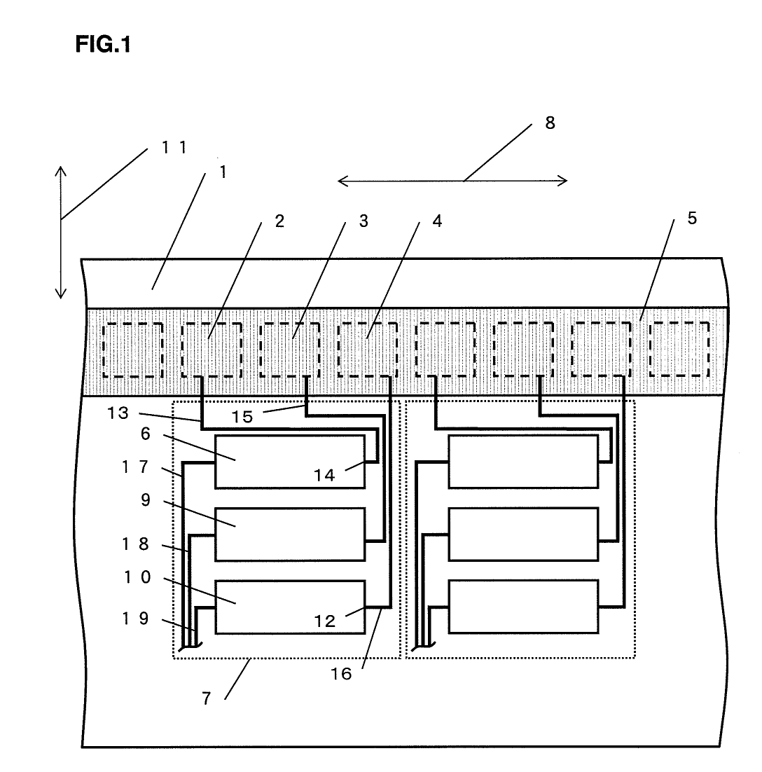

FIG. 1 shows an enlarged pattern view of top surface in a configuration of a portion of a glass substrate 1 where the organic EL element array, the drive circuits and the drive circuit wires are formed in an optical line head contained in the exposure device relating to the present embodiment.

In FIG. 1, an organic EL element 2 is formed on the transparent glass substrate 1, and it has a transparent lower electrode (transparent electrode), an insulating layer that controls an emission region, an emission layer that emits a light and a counter electrode. Organic EL elements 3 and 4, and other organic EL elements are similarly formed.

These multiple organic EL elements are aligned and form the organic EL element array. Herein, this exposure device is for a printer whose resolution is 1,200 dpi, and therefore, the organic EL elements are aligned at pitches of 21.2 μm.

The organic EL element array is a sealed from the upper side of the counter electrode in a sealed region 5. If the organic EL elements are affected by moisture, since the light emitting properties may be deteriorated or the emission region may temporally be contracted or a non light emitting site may be generated within the emission region, the moisture is blocked by the sealing.

A drive circuit is established per organic EL element. A drive circuit 6 corresponding to the organic EL element 2 is composed of a condenser and multiple circuit elements including thin film transistors (TFTs), and it is formed within a region 7 shown in the drawing on the glass substrate 1. This region 7 is situated outside of the organic EL elements, here, outside the sealed region 5 herein, and its length in a column direction 8 of the organic EL elements is approximately 3 pixels of 1,200 dpi. Internal circuit elements are laid out so as to have a roughly-rectangular outer shape of the region occupied by the drive circuit 6 as shown in the drawing. For other drive circuits, such as a drive circuit 9 or a drive circuit 10 corresponding to the organic EL element 3 or 4, respectively, the internal circuit configuration is all the same, and the internal circuit elements are laid out so as to have a roughly-rectangular outer shape of the region occupied by the circuit 9 or 10.

For the drive circuits 6, 9 and 10, as shown in the drawing, the roughly-rectangular region is arranged so as to have its long side direction be in parallel to the column direction 8 of the organic EL element array, respectively. Then, the drive circuits 6, 9 and 10 are arranged in a short side direction 11 of the organic EL element array. In other words, the drive circuit 6 is arranged to be adjacent to the organic EL element array; the drive circuit 9 is arranged outside the drive circuit 6; and the drive circuit 10 is arranged outside the drive circuit 9.

Further, as shown in the drawing, regarding the drive circuit 10, its short side at an output end 12 side in the roughly-rectangular region is arranged substantially at the position of the organic EL element 4 in the column direction 8 of the organic EL element array, and the drive circuit 6 and the drive circuit 9 are also arranged by aligning the positions of the short sides of the roughly-rectangular regions at their short side positions, respectively.

In this layout, the drive circuits are arranged outside the organic EL element array, and since the region occupied by each drive circuit covers two or more organic EL elements exceeding one pitch in the alignment of the organic EL elements, even if the size and alignment of the organic EL elements are not adjusted for the drive circuits, a necessary space for arranging the component elements of the circuit drives can be secured.

A drive circuit wire 13 is made of aluminum with 3 um of width, and is formed on the glass substrate 1 as a wire that electrically connects the output end 14 of the drive circuit 6 to the lower electrode and the counter electrode of the organic EL element 2 via the wire 13. Similarly, a drive circuit wire 15 is formed on the glass substrate 1 as a wire that electrically connects the drive circuit 9 to the organic EL element 3 via the wire 15, and a drive circuit wire 16 is formed as a wire that electrically connects the drive circuit 10 to the organic EL element 4 via the wire 16.

Further, the wiring route of drive circuit wire 16 is laid out so as to lessen waste of the wire length by reducing bends in the wiring route compared to the drive circuit wire 13 and the drive circuit wire 15. Then, the wiring routes of the drive circuit wire 13 and the drive circuit wire 15 are laid out so as to have each wire length be the same or substantially the same as the length of the drive circuit wire 16.

Further, the positions where the organic EL elements 2, 3 and 4 (lower electrode and counter electrode, respectively) are connected to the drive circuit wires 13, 15 and 16 (positions where the wires are extracted) are any position of the outer circumferences of the organic EL elements 2, 3 and 4 (lower electrode and counter electrode) as shown in the drawing, respectively. For example, the organic EL elements 2, 3 and 4 are connected (the wire is extracted) to the drive circuit wires 13, 15 and 16 at the left position from the center of the outer circumference of the element (lower electrode and counter electrode), at substantially the center position of the outer circumference, and at the right position from the center of the outer circumference in the drawing, respectively. Even with this layout, the wiring routes are adjusted so as to have the same length in all of the drive circuit wires 13, 15 and 16.

Control circuit wires 17, 18 and 19 are made of aluminum, and are formed on the glass substrate 1 as wires to a connector (not shown) for connecting the inputs of the drive circuits 6, 9 and 10 to an outside control circuit.

In this embodiment, this configuration is repeated every three pixels, and when signals for controlling the exposure in accordance with image information, which is a subject for printing, are entered into the drive circuits 6, 9 and 10 in the optical line head from the outside control circuit, the drive circuits 6, 9 and 10 supply a predetermined quantity of electric current to the corresponding organic EL elements 2, 3 and 4 when a light is emitted with regard to said organic EL elements according to the input signals, and when no light is emitted, the supply of the electric current is stopped. As described above, the organic EL elements 2, 3 and 4 irradiate a light from the emission layer toward the lower electrode side (toward the back side of this drawing), and predetermined exposure is conducted to the photosensitive body arranged outside the device, respectively.

As described above, the positions where the organic EL elements 2, 3 and 4 are connected to the drive circuit wires 13, 15 and 16 are any positions around the outer circumferences of the organic EL elements 2, 3 and 4, respectively. Even with this wiring, in the organic EL element, since the emission layer interposed by the surfaces of the electrodes emits a light throughout the entire surfaces, the position and shape within the light emitting element do not vary according to the position of the wiring to the electrodes, and a uniform light emission can be obtained in the organic EL element array not depending upon the position of the wires to the electrodes.

Further, the drive circuits 6, 9 and 10 are arranged relative to the organic EL elements 2, 3 and 4 at the positions mentioned above, respectively, and the layout of the drive circuit wires 13, 15 and 16 in the routes described above enables the uniform length of the drive circuit wires 13, 15 and 16, and enables the elimination of waste of the lengths. With this design, the wiring resistance and floating capacitance of the drive circuit wires 13, 15 and 16 can be optimally controlled and made uniform, and variation in the drive performance of the drive circuits 6, 9 and 10 relative to the organic EL elements 2, 3 and 4 per element can be prevented. Even when the lengths of the drive circuit wires are adjusted to be substantially the same, a similar effect can be obtained. In this case, it is preferable that a difference in the lengths between the drive circuit wires is within the range of approximately 10%. As long as the difference is maintained within this range, even if the organic EL elements are temporally deteriorated, it is unnecessary to have a wider coverage and the deterioration can be compensated for with comparatively small-sized drive circuits.

As described above, since the drive circuits 6, 9 and 10 are arranged outside the organic EL element array where the organic EL elements 2, 3 and 4 are aligned, the regions for the organic EL elements 2, 3 and 4 will never be reduced due to the regions for the drive circuits 6, 9 and 10 and it is possible to maximize the regions at predetermined pitches even with high resolution, and the quantity of irradiation light can be sufficiently secured; concurrently, the regions for the drive circuits 6, 9 and 10 can also be larger as occasions demand for that purpose. In this embodiment, having a region equivalent to three pixels of 1,200 dpi enables the arrangement of multiple transistors with approximately 4 μm of size and the wiring in between the transistors, and the circuit layout can be simplified.

Since the drive circuits 6, 9 and 10 are situated outside the sealed regions of the organic EL elements 2, 3 and 4, it prevents the generation of heat in the drive circuits to influence the light emitting elements.

In addition, since the drive circuits 6, 9 and 10 and the organic EL elements 2, 3 and 4 are divided and separately located, the drive circuits 6, 9 and 10 and the organic EL elements 2, 3 and 4 are modulated as an independent circuit block, respectively, with improved flexibility, efficacy and reliability of the circuit design and the internal circuit layout.

In addition, concentration of a region where TFTs are formed results in the prevention of the variation in the performance between the adjacent elements caused by the TFT formation in the production process, and the characteristic can be easily unified, and as a result, an efficacy to prevent the great variation in the performance of the drive circuits is obtained.

Furthermore, each drive circuit occupies a region equivalent to approximately three pixels of 1,200 dpi in this embodiment, and as long as the long side of the region is a length, which is equal to two elements or more with regard to the column of the organic EL elements with any resolution, the similar efficacy can be obtained by adopting the configuration relating to the present invention. In addition, in this embodiment, the configuration where three organic EL elements (for example, the organic EL elements 2, 3 and 4) and three drive circuits (for example, the drive circuits 6, 9 and 10) are regarded as one unit and a similar arrangement is repeated every said unit; however, the similar efficacy can be obtained by adopting the configuration relating to the present invention to two or more of each of the organic EL elements and drive circuits.

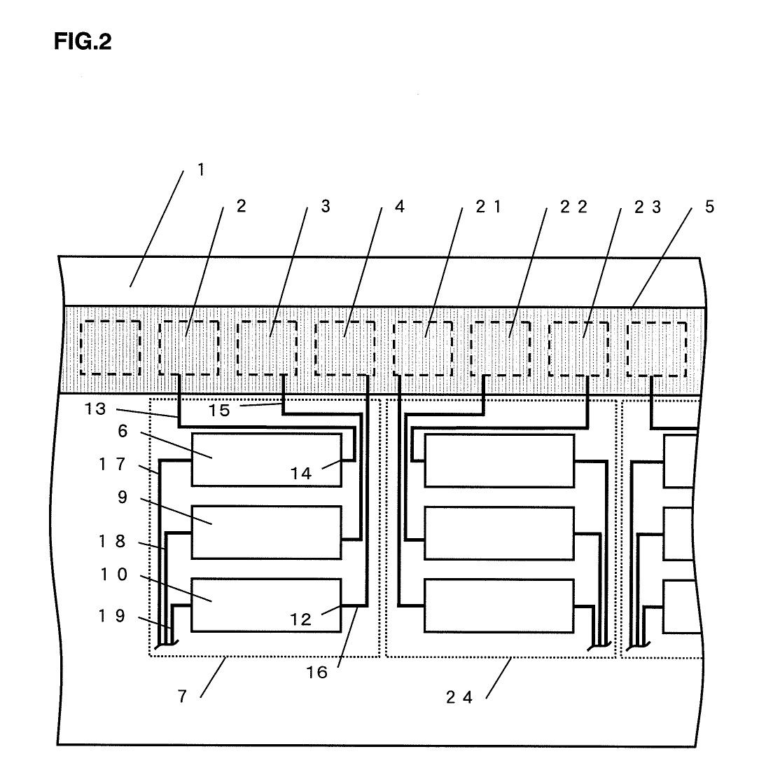

FIG. 2 shows another example of a configuration of a portion of the glass substrate where the organic EL element array, the drive circuits and the drive circuit wires are formed in the optical line head.

This example is the same as the example in FIG. 1 in the point where the configuration where the three drive circuits are arranged is repeated every three pixels within the region outside the sealed region 5 on the glass substrate 1. The length of the region occupied by the drive circuits covers two or more organic EL elements exceeding one pitch in the alignment of the organic EL elements, and these drive circuits are arranged along the organic EL array column.

However, the layout of the region for the three organic EL elements 2 to 4 is different from the layout of an adjacent region 24 for three organic EL elements 21 to 23. In this example, the drive circuits, the drive circuit wires and the control circuit wires are symmetrically arranged between the adjacent regions 7 and 24. This design is similar between other regions for other organic EL elements. The symmetrical layout relative to the boundary between the adjacent regions results in the separation of the drive circuit wires and the control circuit wires, and results in coming close the drive circuit wires each other or the control circuit wires each other, avoiding noise interference between input and output signals.

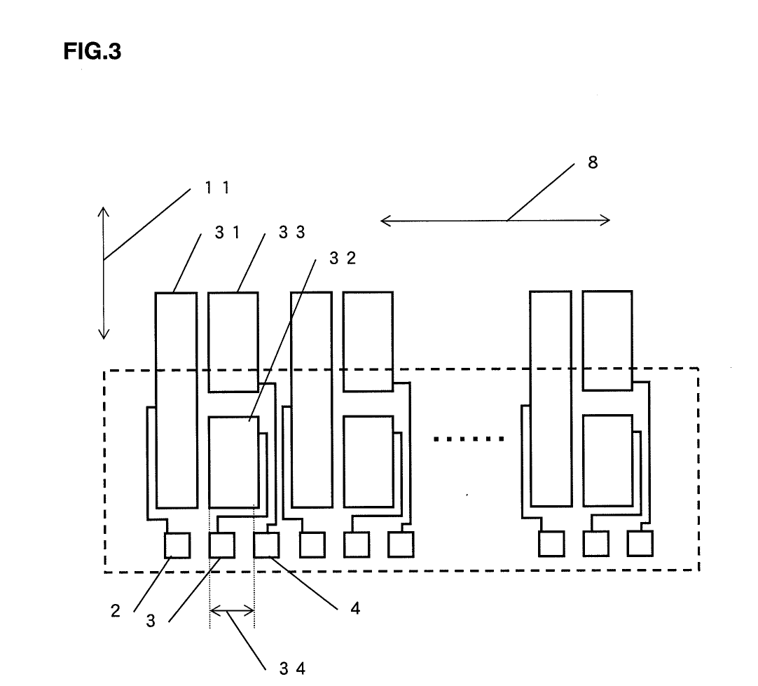

FIG. 3 shows another example of the layout of the organic EL element array, the drive circuits and the drive circuit wires in the optical line head.

This example is also the same as the example in FIG. 1 in the point where the configuration where three roughly-rectangular drive circuits are arranged is repeated every three pixels within the region outside of the organic EL element array on the glass substrate 1. The length of the region occupied by at least one of the three drive drives covers two or more organic EL elements exceeding one pitch in the alignment of the organic EL elements, and these drive circuits are arranged along the organic EL element array row.

However, this example is different from the example in FIG. 1 in the direction and arrangement of the region occupied by drive circuits 31 to 33 relative to the three organic EL elements 2 to 4. In this example, the short sides of those regions are arranged along the column direction 8 of the organic EL element array, and the long sides of those regions are arranged along the short side direction 11 of the organic EL element array.

The outer shape of the region occupied by the drive circuit 31 is different from those occupied by the drive circuits 32 and 33. The long sides of the regions occupied by the drive circuit 32 and 33 are shorter than that of the region occupied by the drive circuit 31, and the short sides of the regions occupied by the drive circuits 32 and 33 are slightly longer than that of the region occupied by the drive circuit 31. The short sides of the regions occupied by the drive circuits 32 and 33 are longer than the pitch 34 of the organic EL element array. The lengths of the regions occupied by the drive circuits 32 and 33 are shorter than two pitches, but at least cover two or more organic EL elements.

The regions occupied by the drive circuits 32 and 33 are linearly arranged in the short side direction 11 of the organic EL element array. In the case of this arrangement, it is preferable that the internal circuit elements in the last stage where the drive circuit wire is extracted is arranged at the portion where the drive circuits 32 and 33 come closer to each other. This is because the lengths of the drive circuit wires can be substantially uniform.

As described above, if the region occupied by a portion of the drive circuits comprising a set of drive circuits relative to a set of organic EL elements has a different outer shape from the region occupied by other drive circuits, the space required for arranging the component elements of the drive circuits can be secured without adjusting the size and alignment of the organic EL elements for drive circuits in the optical line head with high resolution.

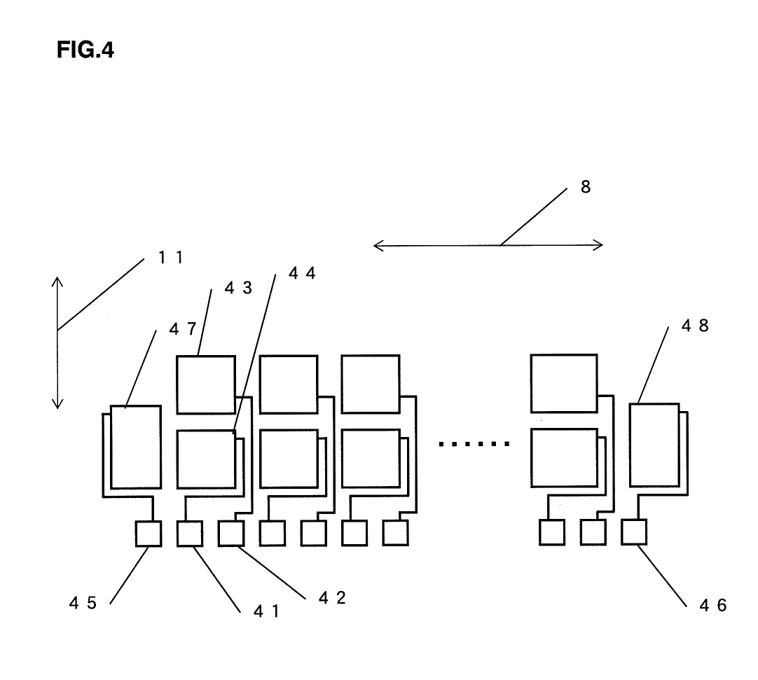

FIG. 4 further shows another example of the layout of the organic EL element array, the drive circuits and the drive circuit wires in the optical line head.

This example is the same as the example in FIG. 1 in the point where the multiple drive circuits are all situated outside the organic EL element array; the point where for at least one or more drive circuits, the length of the region occupied by the drive circuit(s) in the column direction 8 of the organic EL element covers two or more organic EL elements exceeding one pitch in the alignment of the organic EL element; and the point where these multiple drive circuits are arranged along the column of the organic EL elements.

However, this example is different from the example in FIG. 1 in the point where the layout of one set of drive circuits relative to one set of organic EL elements is repeated every one set of organic EL elements is adopted only for a portion of the organic EL elements. In this example, the configuration where the layout of two drive circuits relative to two organic EL elements is repeated every two pixels is adopted in the elements other than the both ends of the organic EL element array, and a different layout is adopted in the organic EL elements at the both ends.

In organic EL elements 41 and 42 other than the both ends of the organic EL element array, a layout where drive circuits 43 and 44 relative to these organic EL elements 41 and 42 are linearly arranged in the short side direction 11 of the organic EL element array is adopted. This layout is repeated every two elements in the organic EL elements other than the both ends of the organic EL element array. The regions occupied by the drive circuits relative to the organic EL element other than the both ends of the organic EL element array are all the same outer shape.

In the meantime, the organic EL elements 45 and 46 at the both ends of the organic EL element array are not in combination with other organic EL elements. In addition, the regions occupied by the drive circuits 47 and 48 relative to the organic EL elements 45 and 46 have a different outer shape from the regions occupied by the drive circuits of the organic EL elements other than the both ends. Since there is normally some space at the both ends of the organic EL element array, the drive circuits 47 and 48 are arranged by projecting from the ends of the organic EL element array by utilizing the space.

As described above, even if the configuration where the layout of a set of the drive circuits relative to a set of the organic EL elements is repeated every one set of the organic EL elements is not adopted to all organic EL elements, a space required for arranging the component elements in the drive circuits can be secured without adjusting the size and alignment of the organic EL elements for the drive circuits in the optical line head with high resolution.

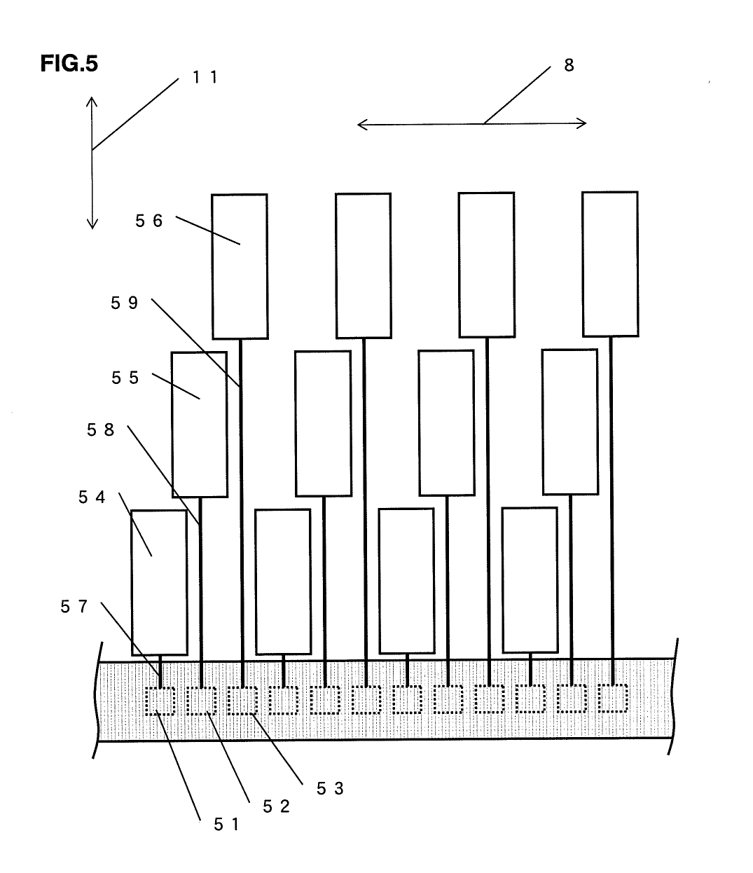

FIG. 5 further shows another example of the layout of the organic EL element array, the drive circuits and the drive circuit wires in the optical line head.

This example is also the same as the example in FIG. 1 in the point where the configuration where the three roughly-rectangular drive circuits are arranged is repeated outside the organic EL element array on the glass substrate 1 every three pixels. The length of the region occupied by at least one of the three drive circuits covers two or more organic EL elements exceeding one pitch in the alignment of the organic EL elements, and these drive circuits are arranged along the column of the organic EL element array.

In the example of FIG. 5, the short side of the region occupied by each drive circuit is arranged in the column direction 8 of the organic EL element array, and the long side of each region is arranged along the short side direction 11 of the organic EL element array.

Organic EL elements 51 to 53 are connected to corresponding drive circuits 54 to 56 by linear drive circuit wires 57 to 59 in the short side direction 11 of the organic EL element array. The drive circuits 54 to 56 and other drive circuits shall be arranged along the column direction 8 of the organic EL element array at the same intervals as pitches of the organic EL element array. However, the length of the region occupied by each drive circuit in the column direction 8 exceeds one pitch of the organic EL element array. The drive circuits are arranged by shifting in the short side direction 11 of the organic EL element array so as not to be overlapped.

In this layout, the lengths of the drive circuit wires vary and the drive performance with regard to the organic EL elements somewhat varies per element. Consequently, it is necessary to compensate for the variation by the drive circuits. It is needless to say, it is easier to control the lengths of the regions where the drive circuits 54 to 56 are arranged in the column direction 8 of the organic EL element array. Therefore, even in the optical line head with high resolution, a necessary space for arranging the elements of the drive circuits can be secured without adjusting the size and alignment of the organic EL elements for the drive circuits.

In the optical line head, the TFT can be made of polysilion. With this design, it is possible to form the TFTs at comparatively lower temperature, and the production can be simpler.

Further, the TFT can be made of amorphous silicon. This enables obtainment of excellent performance and characteristics of the TFTs.

In the embodiment described above, even though sealing of the regions of the drive circuits on the glass substrate 1 is not clearly stated, necessary sealing may be applied to the drive circuits.

Further, in the embodiment described above, the sealed region 5 will never overlap the regions of the drive circuits and is designed for independently sealing the region where the organic EL element array is formed, and with this design, a mutual influence of the generation of heat upon the drive circuits and the organic EL element array is prevented. In a high-speed printer, since high emission luminance becomes necessary and the heat value also becomes greater associated with this, the effect is great. In the meantime, in a low-speed printer, the effect becomes comparatively lower. If the heat value is small and the mutual influence is allowable from the design aspect, the entire region of the organic EL element array and the drive circuits may be sealed. With this design, the production process can be simplified and related cost can be reduced.

Further, in the glass substrate 1 where the organic EL element array, the drive circuit group and the drive circuit wire group are formed, the side of the surface where the organic EL element array, the drive circuit group and the drive circuit wire group are formed may be covered and sealed with a metal conductor case. With this design, in the light emitting circuit of the high density organic EL elements, disturbance, such as induction noise, is difficult to be received and unnecessary radiation can be prevented. With this design, an electric shield at the exterior of the exposure device for high resolution printer can be simplified, and the cost can be reduced. In the printer, since a high voltage charger is arranged around the periphery of the exposure device, disturbance is also less.

In addition, as shown with the broken line in FIG. 3, not the entire glass substrate 1 but a portion may be covered with a conductor. The drive circuit wires are covered and sealed with a metal layer via a moisture absorption layer filled with a drying agent. In the example of FIG. 3, although the drive circuit wires are at least covered, a portion of the drive circuits are not covered with a conductor. As described above, if at least the drive circuit wires are covered with a conductor, it becomes difficult for disturbance, such as induction noise, to affect the input signals to the organic EL elements, and stable operation can be realized as an exposure device.

### Second Embodiment

A device in this embodiment is also an exposure device for an electrophotographic system printer using a photosensitive body similarly to the first embodiment, and the device is equipped with an optical line head having an organic EL element array where multiple organic EL elements are aligned, and each element is controlled and a light is irradiated, and predetermined exposure is conducted to a photosensitive body arranged outside the device. Then, the exposure device in this embodiment is for a printer whose resolution is 2,400 dpi.

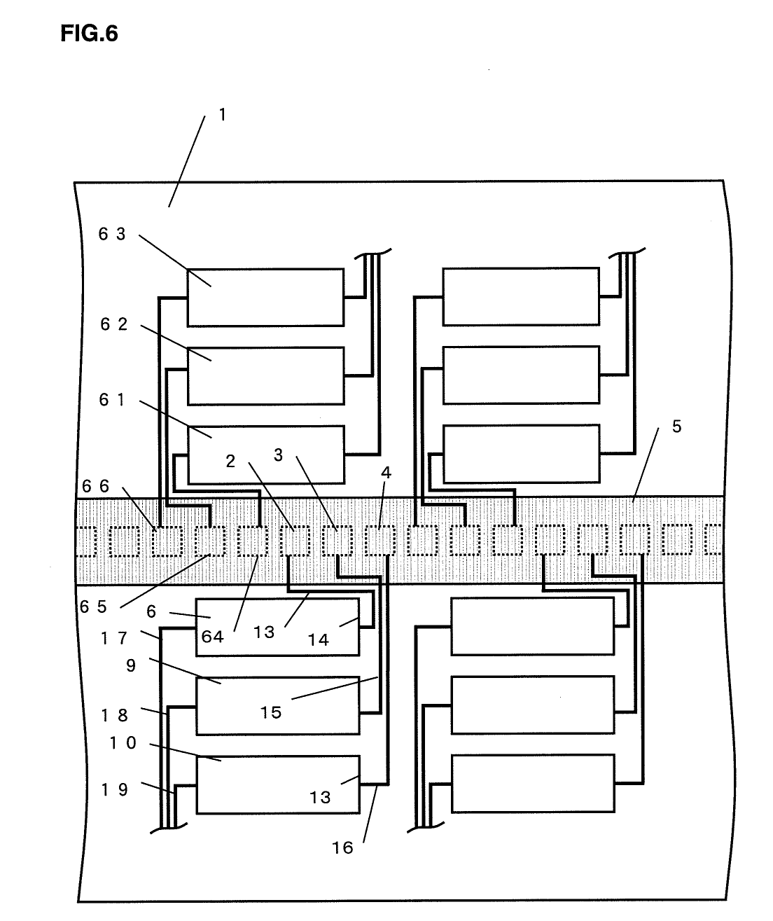

FIG. 6 shows an enlarged pattern of a top surface of a portion of the glass substrate 1 where the organic EL element array, the drive circuits and the drive circuit wires are formed in the optical line head established in the exposure device of this embodiment.

In FIG. 6, the organic EL elements 2, 3 and 4 are composed of a transparent lower electrode (transparent electrode), an insulating layer that controls an emission region, an emission layer that emits a light and a counter electrode (all not shown) formed on the transparent glass substrate 1 as similar to the first embodiment. The multiple organic EL elements are aligned at pitches of 10.6 μm and form the organic EL element array, and the organic EL element array is sealed from above the counter electrode in the sealed region 5.

The drive circuits 6, 9 and 10 and the wires 13, 15 and 16 are laid out similarly to the first embodiment. In this example, drive circuits 61 to 63 are further arranged at the positions facing against the drive circuits 6, 9 and 10 across the organic EL element array as shown in the drawing. The drive circuits 61 to 63 enter drive signals to the three organic EL elements 64 to 66 adjacent to the organic EL elements, respectively. The drive circuits 61 to 63 and their wires are symmetrically laid out relative to the intermediate point of the organic EL element group 2 to 4 and 64 to 66, respectively. Consequently, the positional relationship of the drive circuits 61 to 63 relative to the organic EL element array is similar to that in the first embodiment. Then, this configuration is repeated every double pixel compared to the first embodiment, i.e. every 6 pixels.

As described above, the arrangement of the drive circuits at the both ends of the organic EL element array enables easy application of the present invention with higher resolution compared to the arrangement only at one side, and the similar effect described in the first embodiment can be obtained.

### Third Embodiment

A device of this embodiment is also an exposure device for an electrophotographic system printer using a photosensitive body, and the device is equipped with an optical line head having an organic EL element array where multiple organic EL elements are aligned, and each of the elements is controlled and a light is irradiated, and a predetermined exposure is conducted to a photosensitive body established outside the device.

In the exposure device relating to this embodiment, the optical line head has multiple layers, where drive circuits are formed, overlapped onto the glass substrate 1.

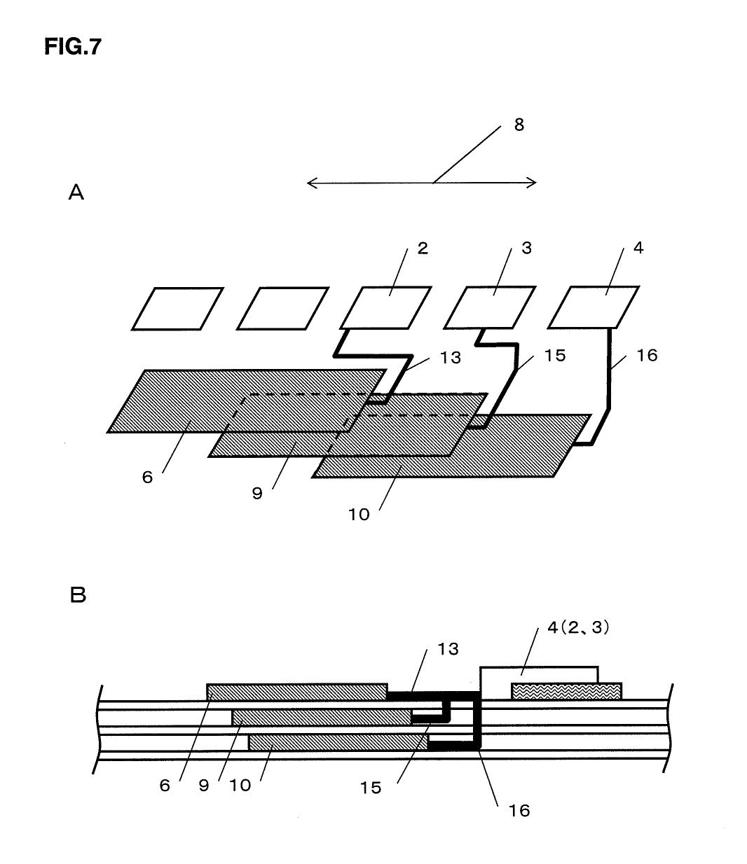

FIG. 7 shows an enlarged pattern of a portion of the organic EL element array where the multiple layers, where the drive circuits are formed, are overlapped onto the glass substrate 1, and FIG. 7A is a perspective view and FIG. 7B is a cross sectional view.

Even in this example, all of the multiple drive circuits are arranged outside the organic EL element array, and the length of the region occupied by the drive circuits in the column direction 8 of the organic EL element array covers two or more organic EL elements exceeding one pitch in the alignment of the organic EL elements.

The drive circuits 6, 9 and 10 relative to the organic EL elements 2, 3 and 4 are formed in the different layers, respectively, and the outer shape of the region occupied by each of these drive circuits 6, 9 and 10 is roughly rectangular. The drive circuits 6, 9 and 10 are arranged along the organic EL elements, respectively.

Taking the interlayer distance into consideration, even in this example, the lengths of the drive circuit wires 13, 15 and 16 are substantially uniform. Further, in order to unify the lengths of the drive circuit wires 13, 15 and 16, the positions where these wires are connected to the organic EL elements 2 to 4 are also adjusted, respectively. With this configuration, the present invention can be easily applied even with higher resolution, and the efficacy described above can be similarly obtained.

In addition, the drive circuits 6, 9 and 10 in the overlapped layers are arranged by slightly shifting in the column direction 8 of the organic EL element from each other. This design enables the avoidance of a section for heat generation to be overlapped one above the other in the multiple drive circuits having the same circuit configuration, and enables the avoidance of local concentration of heat generation.

Each of the embodiments described above is not limited to the technical scope of the present invention, and other embodiments other than the already described ones are variously modifiable or applicable. For example, in the embodiment described above, the organic EL element array where the organic EL elements are aligned is used, and an exposure device having an organic EL element array where organic elements are arranged in multiple lines is also applicable to the present invention.

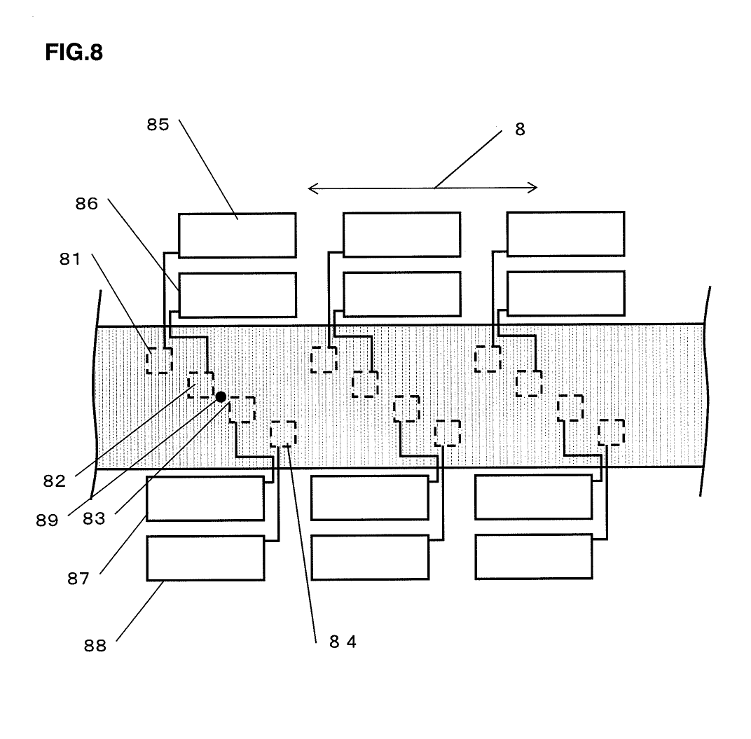

FIG. 8 shows one example of a layout in the optical line head using an organic EL element array where organic EL elements are arranged zigzag. In a printer, the peripheral surface of a photosensitive body where the exposure device irradiates a light rotates in the short side direction (sub-scanning direction) of the organic EL element array. Consequently, when some organic EL elements sequentially emit a light, if the elements are arranged as shown in FIG. 8, a linear latent image can be more precisely formed in the column direction of the organic EL element array (main scanning direction).

As described above, even though the organic EL elements are not aligned, as similar to each of the embodiments described above, it is acceptable as long as the multiple drive circuits are arranged outside the organic EL element array and the drive circuits are arranged along the column of the organic EL element array.

In this organic EL element array, a column of the organic EL element array is formed by repeating the configuration where four organic EL elements are obliquely arranged. For the drive circuits and the drive circuit wires, the same layout is repeated every four pixels.

The regions occupied by drive circuits 85 to 88 corresponding to four organic EL elements 81 to 84 are formed to be rectangular, and the long sides of these regions are arranged in parallel to the column direction 8 of the organic EL element array, and the length of the region occupied by each drive circuit in the column direction 8 covers two or more elements exceeding one pitch in the alignment of the organic EL element.

Consequently, even in the optical line head with high resolution, these drive circuits and wires can be housed within the range of a set of organic EL elements without adjusting the size and alignment of the organic EL elements for the drive circuits.

The drive circuits 85 and 86 and the drive circuits 87 and 88 are arranged in the different regions across the organic EL element array. In this example, the drive circuits 85 and 86 and their drive circuit wires, and the drive circuits 87 and 88 and their drive circuit wires are symmetrically arranged relative to the intermediate point 89 of the organic EL elements 81 and 84.

As described, the symmetrical arrangement of the drive circuits and the drive circuit wires relative to the intermediate point of one set of the organic EL elements, which is a repetition unit of a zigzag arrangement, results in the shortening of the wire length even when the organic EL elements are arranged zigzag. In addition, in this example, in order to prevent the variation in the drive performance with respect to the organic EL element array, the lengths of the drive circuit wires are substantially unified.

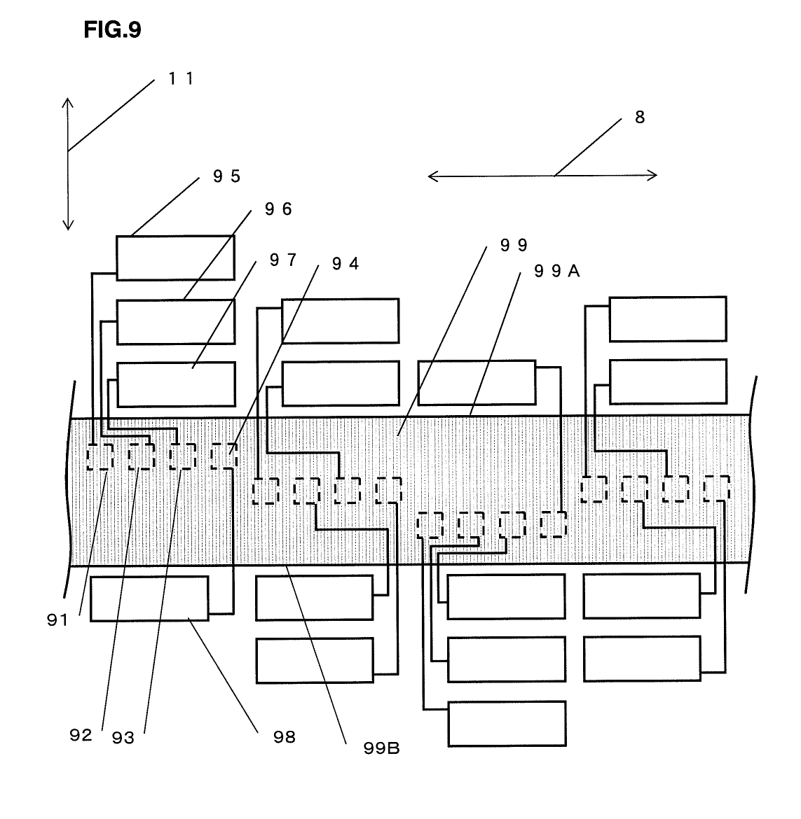

FIG. 9 shows one example of the layout in the optical line head using the organic EL element array where the organic EL element array [sic.; ‘organic EL elements’?] are arranged stepwise. In this organic EL element array, multiple sets of organic EL elements containing four aligned organic EL elements, respectively, are arranged stepwise and a column of the organic EL element array is formed.

The regions of drive circuits 95 to 98 corresponding to four organic EL elements 91 to 94 are formed to be roughly rectangular, and the long sides of these regions are arranged in parallel to the column direction 8 of the organic EL element array. The drive circuits 95 to 98 are arranged outside the organic EL element array, and the length of the region occupied by each drive circuit in the column direction 8 covers two or more elements exceeding one pitch in the alignment of the organic EL element.

Consequently, even in the optical line head with high resolution, these drive circuits and drive circuit wires can be housed within the range of one set of organic EL elements without adjusting the size and alignment of the organic EL elements for the drive circuits.

The drive circuits 95 to 97 and the drive circuits 98 are arranged in the different regions across the organic EL element array. This is because the organic EL elements 91 to 94 are disproportionately arranged at one side 99A side of the sealed region 99 in this example. More drive circuits are arranged in the region closer to the organic EL elements. When the organic EL elements are situated in between the one side 99A and the other side 99B of the sealed region 99, the same number of drive circuits are arranged both in the region at the one side 99A and in the region at the other side 99B. This is because even when multiple sets of organic EL elements are arranged stepwise, while the wire length is substantially unified, the length is shortened as much as possible with this design.

Further, in the embodiments described above, the present invention is applied to the exposure device equipped in a printer, and it is also possible to apply the present invention to the exposure device equipped in other image formation devices, such as copiers, facsimiles or complex machines.

As described above, according to one aspect of the present invention, there is provided an exposure device for irradiating a light to a photosensitive body arranged outside the device, comprising: light emitting elements each configured to emit a light; drive circuits having circuit elements containing thin film transistors, the circuits being formed one on one to the light emitting elements, and being configured to drive light emission of the corresponding light emitting elements; drive circuit wires configured to electrically connect the light emitting elements to the corresponding drive circuits that drive the light emitting elements; and a single substrate where the light emitting elements, drive circuits, and drive circuit wires are formed on the surface, wherein the light emitting elements are densely aligned, and the drive circuits are arranged outside a column formed by the light emitting elements, and, the length of a region occupied by at least one or more circuits in the column direction cover two or more light emitting elements exceeding one pitch in the alignment of the light emitting elements, and the drive circuits are arranged along the column.

With this configuration, in the exposure device, the multiple drive circuits are separately arranged outside the column formed by the multiple light emitting elements, and, the lengths of the regions occupied by all of the circuits are designed to cover two or more light emitting elements exceeding one pitch in the alignment of the light emitting elements, and these multiple drive circuits are arranged along the column. Thereby, the size and alignment of the light emitting elements can be optimum so that it will never be affected by the arrangement of the drive circuits, and, it prevents the generation of heat in the drive circuits from influencing the light emitting elements, and the irradiation light quantity is sufficiently secured even with high resolution, and characteristics and performance are stable.

According to another aspect of the present invention, there is provided an exposure device for irradiating a light to a photosensitive body arranged outside the device, comprising: light emitting elements each configured to emit a light; drive circuits having circuit elements containing thin film transistors, the circuits being formed one on one to the light emitting elements, and being configured to drive light emission of the corresponding light emitting elements; drive circuit wires configured to electrically connect the light emitting elements to the corresponding drive circuits that drive the light emitting elements; and a single substrate where the light emitting elements, drive circuits, drive circuit wires are formed on the surface, wherein the light emitting elements are densely aligned, the drive circuits are arranged outside a column formed by the light emitting elements, and the lengths of regions occupied by all circuits in the column direction cover two or more light emitting elements exceeding one pitch in the alignment of the light emitting elements, and these drive circuits are arranged along the column, and the drive circuit wires are wired so as to be substantially the same in length.

With this configuration, in the exposure device, the multiple drive circuits are separately arranged outside the column formed by the multiple light emitting elements, and, the lengths of the regions occupied by all of the circuits cover two or more light emitting elements exceeding one pitch in the alignment of the light emitting elements, and these multiple drive circuits are arranged along the column, and the lengths of the multiple drive circuit wires are substantially the same and they are wired, respectively, and then, the size and alignment of the light emitting elements are optimized, and, the lengths of the wires are unified and the drive performance is controlled not to vary per element, and the effect of the heat generation in the drive circuits on the light emitting elements are prevented, and the quantity of light irradiation is sufficiently secured with high resolution and characteristics and performance are stable with high resolution and high picture quality with less variation among images.

In the exposure device, the multiple drive circuits may be arranged at the both sides of the column formed by the multiple light emitting elements.

With this configuration, since the arrangement of the multiple drive circuits at the both ends of the column formed by the multiple light emitting elements results in the dispersed arrangement of the drive circuits at the both sides relative to the alignment of the light emitting elements, a maximum value of the distance between the light emitting element and the corresponding drive circuit is decreased, and associated with this, the length of each wire can be shortened and deterioration and variation of the drive performance and characteristics can be prevented, or the exposure device can respond to much higher resolution.

In addition, the substrate can have multiple overlapped layers where the drive circuits are formed, and the multiple drive circuits that drive the adjacent light emitting elements may be situated in the different layers from each other.

With this configuration, since the drive circuits that drive the adjacent light emitting elements are arranged in the different layers from each other, the drive circuits are sterically dispersed and arranged relative to the alignment of the light emitting elements, as well; therefore, a maximum value of the distance between the light emitting element and the drive circuit is further decreased, and associated with this, the length of each wire is further shortened and the variation in the drive performance can be prevented, or the exposure device can respond to further higher resolution.

Further, the drive circuits in the multiple overlapped layers may be arranged at the shifted positioned per layer.

With this configuration, the slightly-shifted arrangement of the drive circuits in the overlapped layers enables the avoidance of the heat generation section from overlapping one above the other and enables the avoidance of the heat generation from being locally concentrated in the multiple drive circuits having the same circuit configuration.

Further, in the preferred embodiments, each light emitting element has a transparent electrode, and the emission of light is driven via this transparent electrode, and the multiple drive circuit wires are wired to have the substantially same length according to the connection position with the transparent electrode, respectively.

With this configuration, the arrangement of the multiple drive circuit wires having the substantially the same length according to the connection position with the transparent electrode, respectively, enables easy adjustment of the length without affecting the light emitting conditions for the light emitting elements in the wiring layout.

Further, as the light emitting element, an organic EL element can be used.

With this configuration, the use of the organic EL element for the light emitting element enables the flexible formation of the shape of the emission region, and enables easy security of quantity of light as an exposure device by maximizing the size of the emission region in each light emitting element in the alignment of the light emitting elements.

Further, for the multiple light emitting elements, their regions may be sealed and the drive circuits may be arranged outside the regions where the multiple light emitting elements are sealed.

With this configuration, the sealing of the regions of the multiple light emitting elements and arrangement of the drive circuits outside the regions where the multiple light emitting elements are sealed cause the transmission of the generation of heat from the drive circuits to the sealed light emitting elements and this effect enables the prevention of the characteristic deterioration from occurring.

In addition, the multiple light emitting elements, drive circuits and drive circuit wires formed on the substrate surface may be partially or entirely covered with a conductor.

With this configuration, the partial or entire sealing of the region of the multiple light emitting elements, drive circuits and drive circuit wires formed on the substrate surface with a conductor, such as metal, makes it difficult to receive disturbance, such as induction noise, in a highly-dense light emitting circuit, and enables the prevention of unnecessary radiation, and this enables the realization of the exterior of the exposure device to be simple electric shield.

### INDUSTRIAL APPLICABILITY

The exposure device relating to the present invention is utilizable for electrophotographic system printers, copiers, facsimiles and small-sized on-demand printers.

1. An exposure device for irradiating a light to a photosensitive body arranged outside the device, comprising:
light emitting elements each configured to emit a light;
drive circuits having circuit elements containing thin film transistors, the circuits being formed one on one to the light emitting elements, and being configured to drive light emission of the corresponding light emitting elements;
drive circuit wires configured to electrically connect the light emitting elements to the corresponding drive circuits that drive the light emitting elements; and
a single substrate where the light emitting elements, drive circuits, drive circuit wires are formed on the surface,
wherein the light emitting elements are densely aligned, and
the drive circuits are arranged outside a column formed by the light emitting elements, and, the length of a region occupied by at least one or more circuits in the column direction exceeds one pitch in the alignment of the light emitting elements, and the drive circuits are arranged along the column.

2. An exposure device for irradiating a light to a photosensitive body arranged outside the device, comprising:
light emitting elements each configured to emit a light;
drive circuits having circuit elements containing thin film transistors, the circuits being formed one on one to the light emitting elements, and being configured to drive light emission of the corresponding light emitting elements;
drive circuit wires configured to electrically connect the light emitting elements to the corresponding drive circuits that drive the light emitting elements; and
a single substrate where the light emitting elements, drive circuits, drive circuit wires are formed on the surface,
wherein the light emitting elements are densely aligned,
the drive circuits are arranged outside a column formed by the light emitting elements, and the lengths of regions occupied by all circuits in the column direction exceed one pitch in the alignment of the light emitting elements, and these drive circuits are arranged along the column, and
the drive circuit wires are wired so as to be substantially the same in length.

3. The exposure device according to claim 1, wherein the drive circuits are arranged at the both sides of the column formed by the light emitting elements.

4. The exposure device according to claim 1, wherein the substrate has multiple overlapped layers where the drive circuits are formed, and
the drive circuits that drive the adjacent light emitting elements are in the different layers from each other.

5. The exposure device according to claim 4, wherein in the overlapped multiple layers, the drive circuits are arranged at the shifted positions per layer.

6. The exposure device according to claim 1, wherein each of the light emitting elements has a transparent electrode connected to the drive circuit wire, and the emission of light is driven via this transparent electrode; and
the lengths of the multiple drive circuit wires are wired so as to be substantially the same according to the connected position with the transparent electrode.

7. The exposure device according to claim 6, wherein the light emitting elements are organic EL elements.

8. The exposure device according to claim 1, wherein the regions of the light emitting elements are sealed, and
the drive circuits are arranged outside the regions where the light emitting elements are sealed.

9. The exposure device according to claim 1, wherein a region formed by the light emitting elements, drive circuits and drive circuit wires formed on the substrate surface is partially or entirely covered with a conductor.
